(19) United States
(12) Patent Application Publication
(10) Pub. No.: US 2017/0140215 A1
(43) Pub. Date: May 18, 2017

(54) GESTURE RECOGNITION METHOD AND VIRTUAL REALITY DISPLAY OUTPUT DEVICE

(71) Applicants: Le Holdings (Beijing) Co., Ltd., Beijing (CN); Le Shi Zhi Xin Electronic Technology (Tianjin) Limited, Tianjin (CN)

(72) Inventor: Chao Zhang, Beijing (CN)

(73) Assignees: Le Holdings (Beijing) Co., Ltd., Beijing (CN); Le Shi Zhi Xin Electronic Technology (Tianjin) Limited, Tianjin (CN)

(21) Appl. No.: 15/240,571

(22) Filed: Aug. 18, 2016

Related U.S. Application Data
(63) Continuation of application No. PCT/CN2016/085365, filed on Jun. 8, 2016.

(30) Foreign Application Priority Data
Nov. 18, 2015 (CN) 201510796509.6

(51) Int. Cl. G06K 9/00; G06T 7/00; G06K 9/62; G06F 3/01

(52) U.S. Cl. CPC G06K 9/00355; G06F 3/017; G06T 7/0083; G06T 7/0097; G06K 9/6277; G06T 2207/10016; G06T 2207/30196; G06T 2207/20081

(57) ABSTRACT

Disclosed are a gesture recognition method for virtual reality display output device and a virtual reality display output electronic device. The recognition method includes: acquiring first and second videos from first and second cameras respectively; separating first and second plane gestures associated with first and second plane information of first and second hand graphs in the first and second video from the first and second videos respectively; converting the first plane information and the second plane information into spatial information using a binocular imaging way, and generating a spatial gesture including the spatial information; acquiring an execution instruction corresponding to the spatial gesture; and executing the execution instruction. The embodiments of the present disclosure can recognize a three-dimensional gesture using an ordinary camera, so as to greatly reduce the cost and technical risks of the virtual reality display output device.

### CROSS REFERENCE TO RELATED APPLICATIONS

This application is a continuation of International Application No. PCT/CN2016/085365, filed on Jun. 8, 2016, which is based upon and claims priority to Chinese Patent Application No. 201510796509.6, filed on Nov. 18, 2015, the entire contents of which are incorporated herein by reference.

### TECHNICAL FIELD

The disclosure relates to the field of virtual reality display related technologies, and more particularly, to a gesture recognition method for virtual reality display output device and a virtual reality display output device.

### BACKGROUND

A virtual reality (Virtual Reality, VR) technology is centered on a computer or other intelligent computing device and combined with a photoelectric sensing technology to generate a vivid virtual environment integrating sight, hearing and touch within a specific range. A virtual reality system mainly includes an input device and an output device. A typical virtual reality display output device is a head mount display (HMD), which enables a user to enjoy an independent and closed immersive interaction experience with the cooperation of the interaction of the input device. Consumables mainly have two HMD product modes at present, wherein one product mode is a PC helmet display device utilizing a personal computer (PC) computing power access way, and the other is a portable helmet display device based on the computing and processing power of a mobile phone.

The VR system may be operated and controlled mainly by a handle, a remote controller, a motion sensor, or the like. Because these operations need to be inputted via an external device, which will always remind the user that the system operated thereof is a virtual reality system, the immersing feeling of the VR system will be severely disrupted. Therefore, a gesture input technical solution is employed in the prior art for the input of the VR system.

Gesture inputs of the prior art on the VR system mainly include: gesture recognition based on a single ordinary camera, resulting in that the immersing feeling is limited since only two-dimensional gestures may be recognized; and a three-dimensional gesture recognition based on dual infrared cameras, resulting in that both the cost and technical risks are high although the immersing feeling is good.

### SUMMARY

This disclosure provides a gesture recognition method for virtual reality display output device and a virtual reality display output electronic device to solve the technical problem that there is no gesture recognition with lower cost and good immersion in the VR system of the prior art.

According to a first aspect, the present disclosure provides a gesture recognition method for virtual reality display output device, including: acquiring a first video from a first camera, and acquiring a second video from a second camera; separating a first plane gesture associated with first plane information of a first hand graph in the first video from the first video, and separating a second plane gesture associated with second plane information of a second hand graph in the second video from the second video; converting the first plane information and the second plane information into spatial information using a binocular imaging way, and generating a spatial gesture including the spatial information; acquiring an execution instruction corresponding to the spatial gesture; and executing the execution instruction.

According to a second aspect, the present disclosure provides a non-transitory computer-readable storage medium storing executable instructions that, when executed by an electronic device with a touch-sensitive display, cause the electronic device to: acquire a first video from a first camera, and acquiring a second video from a second camera; separate a first plane gesture associated with first plane information of a first hand graph in the first video from the first video, and separating a second plane gesture associated with second plane information of a second hand graph in the second video from the second video; convert the first plane information and the second plane information into spatial information using a binocular imaging way, and generating a spatial gesture comprising the spatial information; acquire an execution instruction corresponding to the spatial gesture; and execute the execution instruction.

According to a third aspect, the present disclosure provides a virtual reality display output electronic device, comprising: at least one processor; and a memory communicably connected with the at least one processor for storing instructions executable by the at least one processor, wherein execution of the instructions by the at least one processor causes the at least one processor to: acquire a first video from a first camera, and acquire a second video from a second camera; separate a first plane gesture associated with first plane information of a first hand graph in the first video from the first video, and separate a second plane gesture associated with second plane information of a second hand graph in the second video from the second video; convert the first plane information and the second plane information into spatial information using a binocular imaging way, and generate a spatial gesture comprising the spatial information; acquire an execution instruction corresponding to the spatial gesture; and execute the execution instruction.

According to the embodiments of the present disclosure, the hand graphs are separated from the videos acquired by two cameras and then combined using a binocular imaging way; because the interference of an external environment is avoided after the hand graphs are separated, backgrounds external to the hand graphs are not needed to be computed, and the spatial information of the hand graphs needs to be computed only using a binocular imaging way, so that the computation amount is greatly reduced. Therefore, the spatial information of the hand graphs may be acquired using a very small computation amount, so that a three-dimensional gesture can be recognized using an ordinary camera, thus greatly reducing the cost and technical risks of the virtual reality display output device.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a working flow chart of a gesture recognition method for virtual reality display output device provided by one embodiment of the present disclosure;

FIG. 2 is a working flow chart of a gesture recognition method for virtual reality display output device according to another embodiment of the present disclosure;

FIG. 3 is a structural block diagram of a virtual reality display output device according to another embodiment of the present disclosure; and

FIG. 4 is a structural block diagram of a virtual reality display output device according to another embodiment of the present disclosure.

### DETAILED DESCRIPTION

The present disclosure will be further described in details hereinafter with reference to the drawings and specific embodiments.

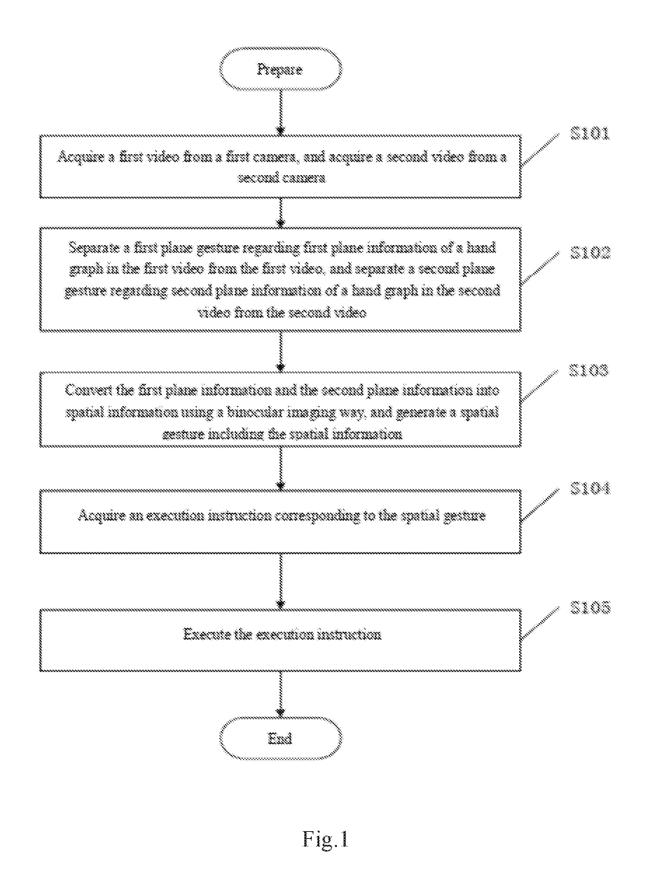

FIG. 1 is a working flow chart of a gesture recognition method for virtual reality display output device provided by one embodiment of the present disclosure, including the following steps: step S101, which includes acquiring a first video from a first camera, and acquiring a second video from a second camera; step S102 which includes separating a first plane gesture associated with first plane information of a first hand graph in the first video from the first video, and separating a second plane gesture associated with second plane information of the second hand graph in the second video from the second video; step S103 which includes converting the first plane information and the second plane information into spatial information using a binocular imaging way, and generating a spatial gesture including the spatial information; step S104 which includes acquiring an execution instruction corresponding to the spatial gesture; and step S105 which includes executing the execution instruction.

A user faces the virtual reality display output device and makes a gesture, wherein the gesture will form hand graphs in the first video and the second video acquired by two ordinary cameras in step S101, and then first plane information and second plane information of the gesture will be separated in step S102. The first plane information and the second plane information refer to a plane position of the first hand graph in the first video and a plane position of the second hand graph in the second video. A single camera can only acquire the plane position; therefore, binocular imaging is further needed in case of acquiring a three-dimensional position. The main function of binocular imaging is binocular distance measurement which mainly utilizes an inversely proportional relationship between the difference (i.e., parallax) of a target point that refers to a hand herein, existing between transverse coordinates imaged on left and right views and the distance from the target point to an imaging plane Z to calculate the distance from the target point (i.e., hand) to the camera by virtue of the parallax caused by the spacing between the two cameras, so as to determine a position of the target object (i.e., hand) in a space as a the spatial information.

Step S104 is executed after the spatial information of the spatial information gesture is acquired, and corresponding instructions are executed in step S105. The user is enabled to interact with the virtual reality display output device using gestures by executing the instructions. The reason why it is difficult for the prior art to employ an ordinary camera for reducing the cost is that an image recorded by the ordinary camera will include a hand and backgrounds near the hand; therefore, it is very difficult to recognize the hand of the user if binocular imaging is directly performed due to the interference of the backgrounds. Therefore, step S102 is executed firstly in the embodiment of the present disclosure to separate a video of each camera as a single video, and after separation step S103 is executed for binocular imaging, so that the interference of the backgrounds during binocular imaging is avoided, and the computation amount is greatly reduced. Therefore, a three-dimensional gesture can be recognized using an ordinary camera, so as to greatly reduce the cost and technical risks of the virtual reality display output device.

In one embodiment, the step S102 specifically includes: separating a first hand graph from each frame of a first image from the first video, acquiring first plane information of the first hand graph separated from each frame of the first image, combining several pieces of first plane information into the first plane gesture, using a time stamp of the first image corresponding to each piece of the first plane information as a time stamp of each piece of the first plane information, separating a second hand graph from each frame of a second image from the second video, acquiring second plane information of the second hand graph separated from each frame of the second image, combining several pieces of second plane information into the second plane gesture, and using a time stamp of the second image corresponding to each piece of the second plane information as a time stamp of each piece of the second plane information; and the step S103 specifically includes: computing the first plane information and the second plane information having the same time stamp into spatial information using the binocular imaging way, and generating the spatial gesture including the spatial information.

According to the embodiment, the hand graphs are separated from each frame of image, and corresponding time stamps are established; then in step S103, the first plane information and the second plane information having the same time stamp are converted into the spatial information, so that the spatial information is computed more accurately.

In one embodiment, the first hand graph is separated from each frame of the first image from the first video using a hand-detection and hand-tracing way, and the second hand graph is separated from each frame of the second image from the second video using a hand-detection and hand-tracing way.

The hand direction employed in the embodiment includes: detection based on skin tones, detection based on motion information, detection based on features, and detection based on image segmentation target, etc. The hand tracing includes: employing such tracing algorithms like particle tracing, CamShift algorithm, or the like, which may also be combined with Kalman filtering to achieve a preferable effect.

The embodiment enables the hand graphs to be separated more accurately by using a hand detection and hand tracing way, so that the subsequent spatial information computation becomes more accurate, and a more accurate spatial gesture can be recognized.

In one embodiment, the first plane information includes first moving part plane information of at least one moving part in the first hand graph, and the second plane information includes second moving part plane information of at least one moving part in the second hand graph; and the S103 specifically includes: computing moving part spatial information of a moving part for the first moving part plane information and the second moving part plane information of the same moving part having the same stamp using a binocular imaging way, and generating a spatial gesture including at least one piece of the moving part spatial information.

The moving part refers to a movable part of a hand, for example, fingers, or the like. The moving part may be designated in advance; because the hand graphs have been separated, interference of other backgrounds is avoided, while the moving part is generally at the edge of the hand graph; therefore, the moving part may be recognized very conveniently through a way of extracting edge features, or the like.

In the embodiment, the moving part spatial information of the moving part is further computed, so that more exquisite gestures can be recognized.

In one embodiment, the step S104 specifically includes: inputting the spatial gesture into a gesture classification model to obtain a gesture category of the spatial gesture, and acquiring an execution instruction corresponding to the gesture category, the gesture classification model being a classification model associated with the category of the spatial gesture obtained using machine learning to train a plurality of spatial gestures acquired in advance.

The input of the gesture classification model is a spatial gesture, and the output thereof is a gesture category. The machine learning may be executed in a supervised way, for example, the category of each spatial gesture used for training is designated during a supervised training, and then the gesture classification model is acquired by multiple training. The machine learning may also be executed in an unsupervised way, for example, category classification. For example, a k-nearest neighbor algorithm (k-Nearest Neighbor algorithm, KNN) is employed to classify the spatial gestures used for training according to the spatial positions thereof.

In the embodiment, the gesture classification model is established in a machine learning way, which facilitates classifying the gestures, so that the robustness of gesture recognition is increased.

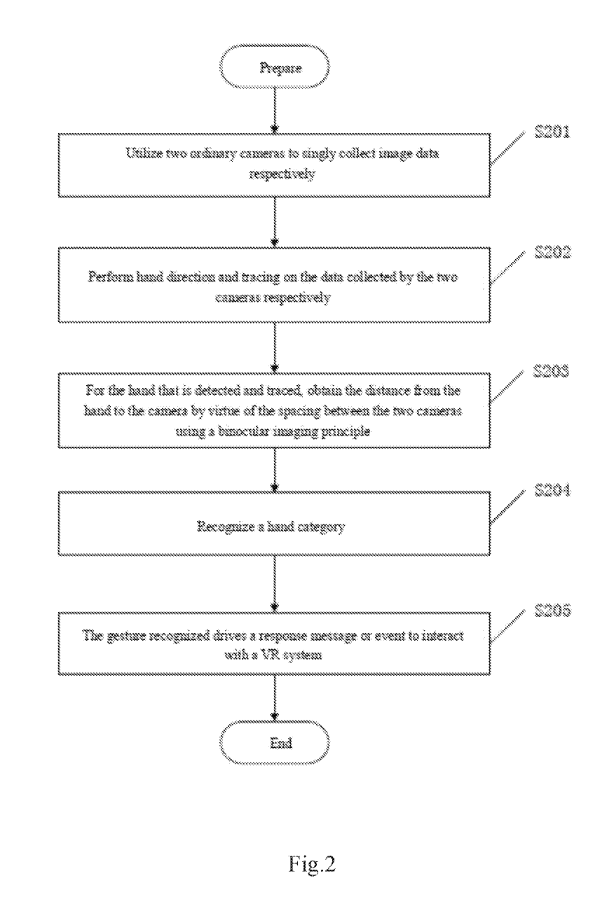

FIG. 2 is a working flow chart of a gesture recognition method for virtual reality display output device provided by another embodiment of the present disclosure, including the following steps.

In step S201, two ordinary cameras are utilized to singly collect image data respectively.

A user faces a virtual reality display output device and makes a gesture, wherein the gesture will form hand graphs in a first video and a second video acquired by the two ordinary cameras.

In step S202, hand-detection and hand-tracing are performed on the data collected by the two cameras respectively.

Several methods may be employed during detection, such as detection based on skin tone, detection based on motion information, detection based on features, and detection based on image segmentation target, etc. During hand-tracing, such tracing algorithms like particle tracing, CamShift algorithm, or the like may be employed, which may also be combined with Kalman filtering to achieve a preferable effect.

In step S203, for the hand that has been detected and traced, a distance from the hand to the camera is obtained by virtue of a spacing between the two cameras using a binocular imaging principle.

There is an inversely proportional relationship between the difference (i.e., parallax) of a target point existing between transverse coordinates imaged on left and right views and the distance Z from the target point to an imaging plane, and the distance from the target point (i.e., hand) to the camera is calculated by virtue of the parallax caused by the spacing between the two cameras.

In step S204, the information of the hand acquired at this moment not only includes tone information, but also includes position information of the hand in a space; then the hand category may be recognized at this moment, and gesture recognition in a three-dimensional sense may also be performed.

In step S205, the gesture recognized drives a response message or event to interact with a VR system.

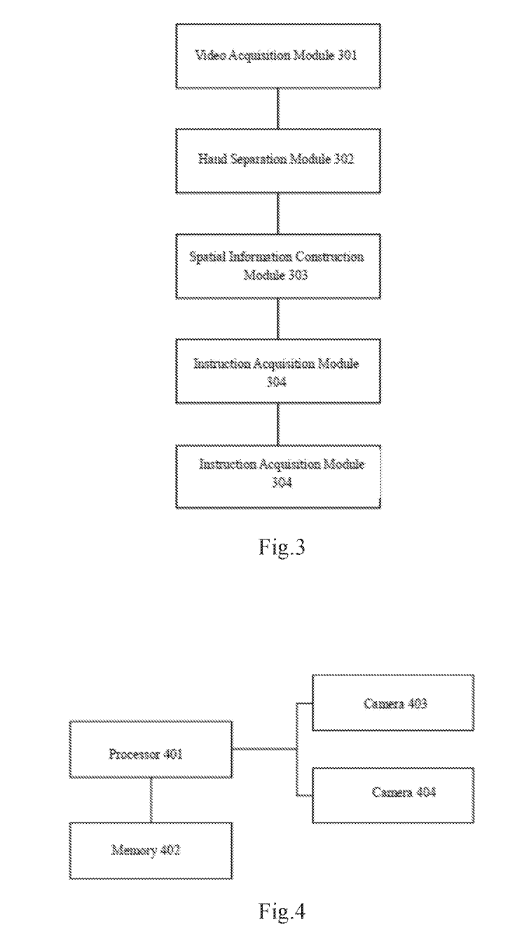

FIG. 3 is a structural block diagram of a virtual reality display output device provided by one embodiment of the present disclosure, including: a video acquisition module 301 configured to: acquire a first video from a first camera, and acquire a second video from a second camera; a hand separation module 302 configured to: separate a first plane gesture associated with first plane information of a first hand graph in the first video from the first video, and separate a second plane gesture associated with second plane information of a second hand graph in the second video from the second video; a spatial information construction module 303 configured to: convert the first plane information and the second plane information into spatial information using a binocular imaging way, and generate a spatial gesture including the spatial information; an instruction acquisition module 304 configured to: acquire an execution instruction corresponding to the spatial gesture; and an execution module 305 configured to: execute the execution instruction.

The embodiment of the present disclosure can recognize a three-dimensional gesture using an ordinary camera, so as to greatly reduce the cost and technical risks of the virtual reality display output device.

In one embodiment, the hand separation module 302 is specifically configured to: separate a first hand graph from each frame of a first image from the first video, acquire first plane information of the first hand graph separated from each frame of the first image, combine several pieces of first plane information into the first plane gesture, use a time stamp of the first image corresponding to each piece of the first plane information as a time stamp of each piece of the first plane information, separate a second hand graph from each frame of a second image from the second video, acquire second plane information of the second hand graph separated from each frame of the second image, combine several pieces of second plane information into the second plane gesture, and use a time stamp of the second image corresponding to each piece of the second plane information as a time stamp of each of the second plane information; and

the spatial information construction module 303 is specifically configured to: compute the first plane information and the second plane information having the same time stamp into spatial information using the binocular imaging way, and generate the spatial gesture including the spatial information.

The embodiment enables the spatial information to be computed more accurately.

In one embodiment, the first hand graph is separated from each frame of the first image from the first video using a hand-detection and hand-tracing way, and the second hand graph is separated from each frame of the second image from the second video using a-hand detection and hand-tracing way.

The embodiment enables the hand graphs to be separated more accurately using a hand detection and hand tracing way, so that the subsequent spatial information computation is more accurate, and a more accurate spatial gesture can be recognized.

In one embodiment, the first plane information includes first moving part plane information of at least one moving part in the first hand graph, and the second plane information includes second moving part plane information of at least one moving part in the second hand graph; and the spatial information construction module is specifically configured to: compute moving part spatial information of a moving part for the first moving part plane information and the second moving part plane information of the same moving part having the same stamp using a binocular imaging way, and generate a spatial gesture including at least one of the moving part spatial information.

In the embodiment, the moving part spatial information of the moving part is further computed, so that more exquisite gestures can be recognized.

In one embodiment, the instruction acquisition module 304 is specifically configured to: input the spatial gesture into a gesture classification model to obtain a gesture category of the spatial gesture, and acquire an execution instruction corresponding to the gesture category, the gesture classification model being a classification model associated with the category of the spatial gesture obtained using machine learning to train a plurality of spatial gestures acquired in advance.

In the embodiment, the gesture classification model is established using a machine learning way, which facilitates classifying the gestures, so that the robustness of gesture recognition is increased.

FIG. 4 shows a structural block diagram of a virtual reality display output device provided by one embodiment of the present disclosure. The virtual reality display output device may be a PC helmet display device using a PC computing power access way, or a portable helmet display device based on the computing and processing power of a mobile phone, or a helmet display device self-provided with computing and processing power of a mobile phone, which mainly includes: a processor 401, a memory 402, two cameras 403, and the like.

Wherein, specific codes of the forgoing method are stored in the memory 402 and are specifically executed by the processor 401, gestures are captured through the cameras 403, and processed by the processor 401 according to the forgoing method, and then corresponding operations are executed.

Moreover, a logic instruction in the memory 402 above, if being implemented through a software function unit and sold or used as an independent product, may be stored in a computer-readable storage medium. Based on such understanding, the technical solution of the present disclosure essentially, or the part contributing to the prior art, or the part of the technical solution may be implemented in the form of a software product. The computer software product is stored in a storage medium, and includes several instructions for instructing a mobile terminal (which may be a personal computer, a server, or a network device so on) to execute all or a part of steps of the method according to each embodiment of the present disclosure. The abovementioned storage medium includes: any medium that is capable of storing program codes, such as a USB disk, a mobile hard disk drive, a read-only memory (ROM), a random access memory (RAM), a magnetic disk, an optical disk, or the like.

The device embodiments described above are only exemplary, wherein the units illustrated as separation parts may either be or not physically separated, and the parts displayed by units may either be or not physical units, i.e., the parts may either be located in the same plate, or be distributed on a plurality of network units. A part or all of the modules may be selected according to an actual requirement to achieve the objectives of the solutions in the embodiments of the present disclosure. Those having ordinary skills in the art may understand and implement without going through creative work.

Through the above description of the implementation manners, those skilled in the art may clearly understand that each implementation manner may be achieved in a manner of combining software and a necessary common hardware platform, and certainly may also be achieved by hardware. Based on such understanding, the foregoing technical solutions essentially, or the part contributing to the prior art may be implemented in the form of a software product. The computer software product may be stored in a storage medium such as a ROM/RAM, a diskette, an optical disk or the like, and includes several instructions for instructing a computer device (which may be a personal computer, a server, or a network device so on) to execute the method according to each embodiment or some parts of the embodiments.

Another embodiment of the present disclosure provides a nonvolatile computer-readable storage medium which stores executable instructions, wherein the above gesture recognition methods according to any one embodiment as above can be performed by the executable instructions.

The memory can be used as a nonvolatile computer-readable storage medium, which can store a nonvolatile software program, a nonvolatile computer-executable program, and respective modules. For example, the medium stores program instructions/modules for performing the gesture recognition method according to the embodiments of the present disclosure, such as the video acquisition module 301, the hand separation module 302, the spatial information construction module 303, the instruction acquisition module 304 and the execution module 305. The processor executes the nonvolatile software program, instructions and/or modules stored within the memory , so as to perform several functional applications and data processing, particularly, perform the gesture recognition methods for virtual reality display output device according to the above embodiments as above.

The memory may include a storage program zone and a storage data zone. The storage program zone may store an operating system and at least one application program for achieving respective functions. The storage data zone may store data created according to the usage of the icon sequencing device. In addition, the memory may further include a high speed random access memory and a nonvolatile memory, e.g. at least one of a disk storage device, a flash memory or other nonvolatile solid storage device. In some embodiments, the memory may include a remote memory remotely located relative to the processor, and this remote memory may be connected, via a network, to the icon sequencing device for an intelligent television desktop. For example, the network includes but is not limited within internet, intranet, local area network, mobile communication network and any combination thereof.

One or more storage modules are stored within the memory. When said one or more storage modules are operated by one or more processor, the virtual reality display output methods of the above embodiments are performed.

The products as above-mentioned may perform methods provided by the embodiments of the present disclosure, have functional modules for performing the methods, and achieve respective beneficial effects. For those technical details which are not mentioned in this embodiment, please refer to the methods provided by the embodiments of the disclosure.

The electronic device of the embodiment of the present disclosure may be constructed in several forms, which include but are not limited within:

(1) mobile communication device: this type of terminal has a function of mobile communication for main propose of providing a voice/data communication. This type of terminal includes: a smartphone (e.g. iPhone), a multimedia mobile phone, a feature phone, a low-end cellphone and so on;

(2) ultra mobile personal computer device: this type of terminal belongs to a personal computer which has a computing function and a processing function. In general, this type of terminal has a networking characteristic. This type of terminal includes: PDA, MID, UMPC and the like, e.g. iPad;

(3) portable entertainment device: this type of device can display and play multimedia contents. This type of device includes an audio/video player (e.g. iPod), a handheld game console, an electronic book, an intelligent toy, and a portable vehicle navigation device;

(4) server: the server provides a computing service. The construction of a server includes a processor, a hard disk, an internal memory, a system bus and so on, which is similar to the construction of a general computer but can provide more reliable service. Therefore, with respect to processing ability, stability, reliability, security, extendibility and manageability, a server has to meet a higher requirement; and

(5) other electronic devices having data interchanging functions.

It should be finally noted that the above embodiments are only configured to explain the technical solutions of the embodiments of the present application, but are not intended to limit the present application. Although the embodiments of the present disclosure has been illustrated in detail according to the foregoing embodiments, those having ordinary skills in the art should understand that modifications can still be made to the technical solutions recited in various embodiments described above, or equivalent substitutions can still be made to a part of technical features thereof, and these modifications or substitutions will not make the essence of the corresponding technical solutions depart from the spirit and scope of the claims.

What is claimed is:

1. A virtual reality display output electronic device, comprising:
at least one processor; and
a memory communicably connected with the at least one processor for storing instructions executable by the at least one processor, wherein execution of the instructions by the at least one processor causes the at least one processor to:
acquire a first video from a first camera, and acquire a second video from a second camera;
separate a first plane gesture associated with first plane information of a first hand graph in the first video from the first video, and separate a second plane gesture associated with second plane information of a second hand graph in the second video from the second video;
convert the first plane information and the second plane information into spatial information using a binocular imaging way, and generate a spatial gesture comprising the spatial information;
acquire an execution instruction corresponding to the spatial gesture; and
execute the execution instruction.

2. The virtual reality display output electronic device according to claim 1, wherein the processor is further configured to:
separate the first hand graph from each frame of a first image from the first video, acquire first plane information of the first hand graph separated from each frame of the first image, combine a plurality of pieces of first plane information into the first plane gesture, use a time stamp of the first image corresponding to each piece of the first plane information as a time stamp of each of the first plane information, separate the second hand graph from each frame of a second image from the second video, acquire second plane information of the second hand graph separated from each frame of the second image, combine a plurality of pieces of second plane information into the second plane gesture, and use a time stamp of the second image corresponding to each piece of the second plane information as a time stamp of each of the second plane information; and
compute the first plane information and the second plane information having the same time stamp into spatial information using the binocular imaging way, and generate the spatial gesture comprising the spatial information.

3. The virtual reality display output electronic device according to claim 2, wherein the processor is further configured so that the first hand graph is separated from each frame of the first image from the first video using a hand detection and hand tracing way, and the second hand graph is separated from each frame of the second image from the second video using the hand detection and hand tracing way.

4. The virtual reality display output electronic device according to claim 2, wherein the processor is further configured so that the first plane information comprises first moving part plane information of at least one moving part in the first hand graph, and the second plane information comprises second moving part plane information of at least one moving part in the second hand graph; and
the processor is further: based on the first moving part plane information and the second moving part plane information of the same moving part having the same stamp, compute moving part spatial information of the moving part using the binocular imaging way, and generate the spatial gesture comprising at least one of the moving part spatial information.

5. The virtual reality display output electronic device according to claim 1, wherein the processor is further configured to:
input the spatial gesture into a gesture classification model to obtain the gesture category of the spatial gesture, and acquire an execution instruction corresponding to the gesture category, the gesture classification model being a classification model regarding the category of the spatial gesture obtained using machine learning to train a plurality of spatial gestures acquired in advance.

6. A gesture recognition method for a virtual reality display output electronic device, comprising:
acquiring a first video from a first camera, and acquiring a second video from a second camera;
separating a first plane gesture associated with first plane information of a first hand graph in the first video from the first video, and separating a second plane gesture associated with second plane information of a second hand graph in the second video from the second video;
converting the first plane information and the second plane information into spatial information using a binocular imaging way, and generating a spatial gesture comprising the spatial information;
acquiring an execution instruction corresponding to the spatial gesture; and
executing the execution instruction.

7. The gesture recognition method for a virtual reality display output electronic device according to claim 6, wherein:
the separating the first plane gesture associated with first plane information of the first hand graph in the first video from the first video, and separating the second plane gesture associated with second plane information of the second hand graph in the second video from the second video comprises:
separating the first hand graph from each frame of a first image from the first video, acquiring first plane information of the first hand graph separated from each frame of the first image, combining a plurality of pieces of first plane information into the first plane gesture, using a time stamp of the first image corresponding to each piece of the first plane information as a time stamp of each of the first plane information, separating a second hand graph from each frame of a second image from the second video, acquiring second plane information of the second hand graph separated from each frame of the second image, combining a plurality of pieces of second plane information into the second plane gesture, and using a time stamp of the second image corresponding to each of the second plane information as a time stamp of each piece of the second plane information; and
the converting the first plane information and the second plane information into spatial information using the binocular imaging way, and generating the spatial gesture comprising the spatial information specifically comprises:
computing the first plane information and the second plane information having the same time stamp into spatial information using the binocular imaging way, and generating the spatial gesture comprising the spatial information.

8. The gesture recognition method for a virtual reality display output electronic device according to claim 7, wherein the first hand graph is separated from each frame of the first image from the first video using a hand detection and hand tracing way, and the second hand graph is separated from each frame of the second image from the second video using the hand detection and hand tracing way.

9. The gesture recognition method for a virtual reality display output electronic device according to claim 7, wherein the first plane information comprises first moving part plane information of at least one moving part in the first hand graph, and the second plane information comprises second moving part plane information of at least one moving part in the second hand graph; and
the converting the first plane information and the second plane information into spatial information using the binocular imaging way, and generating the spatial gesture comprising the spatial information comprises:
based on the first moving part plane information and the second moving part plane information of the same moving part having the same stamp, computing moving part spatial information of the moving part using the binocular imaging way, and generating the spatial gesture comprising at least one piece of the moving part spatial information.

10. The gesture recognition method for a virtual reality display output electronic device according to claim 6, wherein the acquiring the execution instruction corresponding to the spatial gesture comprises:
inputting the spatial gesture into a gesture classification model to obtain a gesture category of the spatial gesture, and acquiring an execution instruction corresponding to the gesture category, the gesture classification model being a classification model associated with the category of the spatial gesture obtained using machine learning to train a plurality of spatial gestures acquired in advance.

11. A non-transitory computer-readable storage medium storing executable instructions that, when executed by an electronic device with a touch-sensitive display, cause the electronic device to:
acquire a first video from a first camera, and acquire a second video from a second camera;
separate a first plane gesture associated with first plane information of a first hand graph in the first video from the first video, and separate a second plane gesture associated with second plane information of a second hand graph in the second video from the second video;
convert the first plane information and the second plane information into spatial information using a binocular imaging way, and generate a spatial gesture comprising the spatial information;
acquire an execution instruction corresponding to the spatial gesture; and
execute the execution instruction.

12. The non-transitory computer-readable storage medium according to claim 11, wherein:
the separating the first plane gesture associated with first plane information of the first hand graph in the first video from the first video, and separating the second plane gesture associated with second plane information of the second hand graph in the second video from the second video comprises:
separating the first hand graph from each frame of a first image from the first video, acquiring first plane information of the first hand graph separated from each frame of the first image, combining a plurality of pieces of first plane information into the first plane gesture, using a time stamp of the first image corresponding to each piece of the first plane information as a time stamp of each of the first plane information, separating a second hand graph from each frame of a second image from the second video, acquiring second plane information of the second hand graph separated from each frame of the second image, combining a plurality of pieces of second plane information into the second plane gesture, and using a time stamp of the second image corresponding to each of the second plane information as a time stamp of each piece of the second plane information; and
the converting the first plane information and the second plane information into spatial information using the binocular imaging way, and generating the spatial gesture comprising the spatial information specifically comprises:
computing the first plane information and the second plane information having the same time stamp into spatial information using the binocular imaging way, and generating the spatial gesture comprising the spatial information.

13. The non-transitory computer-readable storage medium according to claim 12, wherein the first hand graph is separated from each frame of the first image from the first video using a hand detection and hand tracing way, and the second hand graph is separated from each frame of the second image from the second video using the hand detection and hand tracing way.

14. The non-transitory computer-readable storage medium according to claim 12, wherein the first plane information comprises first moving part plane information of at least one moving part in the first hand graph, and the second plane information comprises second moving part plane information of at least one moving part in the second hand graph; and
the converting the first plane information and the second plane information into spatial information using the binocular imaging way, and generating the spatial gesture comprising the spatial information comprises:
based on the first moving part plane information and the second moving part plane information of the same moving part having the same stamp, computing moving part spatial information of the moving part using the binocular imaging way, and generating the spatial gesture comprising at least one piece of the moving part spatial information.

15. The non-transitory computer-readable storage medium according to claim 11, wherein the acquiring the execution instruction corresponding to the spatial gesture comprises:
inputting the spatial gesture into a gesture classification model to obtain a gesture category of the spatial gesture, and acquiring an execution instruction corresponding to the gesture category, the gesture classification model being a classification model associated with the category of the spatial gesture obtained using machine learning to train a plurality of spatial gestures acquired in advance.
